(19) United States
(12) Patent Application Publication
(10) Pub. No.: US 2004/0034588 A1
(43) Pub. Date: Feb. 19, 2004

(54) Concentrated money management system

(76) Inventors: Masakazu Arikawa, Kanagawa (JP); Hiroshi Kurihara, Kanagawa (JP)

Correspondence Address: William S Frommer, Frommer Lawrence & Haug, 745 Fifth Avenue, New York, NY, 10151, US

(21) Appl. No.: 10/415,787

(22) PCT Filed: Aug. 7, 2002
(86) PCT No.: PCT/JP02/08085

(30) Foreign Application Priority Data
Sep. 7, 2001 (JP) 2001-271744

(51) Int. Cl. G06F 17/60

(52) U.S. Cl. 705/36

(57) ABSTRACT

A concentrated fund-management system facilitates fund management of group companies. Settlement conditions (usance and settlement date) are unified among the group companies. For group companies for which financing becomes difficult by the unification of the settlement conditions, negative balances in a deposit table and loaning by the concentrated fund-management system to group companies are allowed, facilitating financing for the group companies.

### TECHNICAL FIELD

The present invention relates to a concentrated fund-management system, a concentrated fund-management method, and a storage medium storing a concentrated fund-management program, for example, for concentrated management of funds of group companies constituting a group.

### BACKGROUND ART

Recently, organization of companies into groups, such as business collaborations among companies, company systems in which a plurality of business units exists in a company, and foundation of holding companies for supervising a plurality of companies, is in progress.

These company groups take advantage of group organizations to achieve higher efficiency and streamlining of businesses in various ways.

One approach for achieving higher efficiency and streamlining of businesses is a concentrated fund-management system, in which the entire funds of group companies are concentrated and managed. In the system, funds of companies constituting a group is concentrated in a single bank account for each currency unit, and balances of a deposit table, representing specifics of holdings of each of the group companies, are increased or decreased, thereby settling transactions among the group companies in a cashless manner. This eliminates the need for actual remittance for transactions among the group companies.

Setting of usance for transactions among group companies has been different from company to company in known concentrated fund-management systems. A usance refers to a grace period for payment. That is, when a commercial transaction takes place, the price is paid after an elapse of a predetermined grace period from delivery of the product. During the usance, the price of purchase becomes an account payable, which is a liability without interest. For example, in the case of a company for which usance is set to be 60 days and settlement date is set to be the 15th of each month, accounts payable for products purchased in April are settled on June 15. This is only an example, and settlement methods are determined individually by companies and customers.

As usance becomes longer, financing is facilitated for a payer company while financing becomes difficult for a payee company. Since usance and financing are closely related as described above, known concentrated fund-management systems have had an aspect that convenience of financing for each group company has been compensated by long or short usance.

Furthermore, in known concentrated fund-management systems, usance has not been unified for transactions among group companies. Thus, work of fund management has been laborious since balances in a deposit table cannot be updated on the same date.

Accordingly, it is an object of the present invention to provide a concentrated fund-management system and the like that allow funds of group companies to be managed efficiently.

### DISCLOSURE OF INVENTION

In order to achieve the above object, the present invention (1) provides a concentrated fund-management system for concentrating and managing funds of companies constituting a group in a fund-concentrating account including a single account for each currency unit, wherein a settlement condition is unified among the companies constituting the group.

The present invention (2) provides a concentrated fund-management system according to (1), wherein the settlement condition that is unified is a grace period for payment.

The present invention (3) provides a concentrated fund-management system according to (1), wherein the settlement condition that is unified is a settlement date.

The present invention (4) provides a concentrated fund-management system according to (1), further comprising a deposit table for storing. specifics of a fund balance for each of the companies in the fund-concentrating account; account-payable-information obtaining means for obtaining account-payable information regarding a price to be paid under a unified settlement condition for payment from a company belonging to the group to another company belonging to the group; and updating means for updating a balance in the deposit table based on the account-payable information obtained by the account-payable-information obtaining means.

The present invention (5) provides a concentrated fund-management system according to (4), wherein a negative balance within a predetermined amount is allowed in the deposit table, and loaning means for loaning a fund to a company belonging to the group in response to a request from the company is further provided.

The present invention (6) provides a concentrated fund-management method for a computer comprising a deposit table, account-payable-information obtaining means, and updating means, the computer being used for concentrating and managing funds of companies constituting a group in a fund-concentrating account including a single account for each currency unit, the concentrated fund-management method comprising a storing step of storing in the deposit table specifics of a fund balance for each of the companies in the fund-concentrating account; an account-payable-information obtaining step of obtaining, by the account-payable-information obtaining means, account-payable information regarding a price to be paid under a unified settlement condition for payment from a company belonging to the group to another company belonging to the group; and a step of updating, by the updating means, a balance in the deposit table based on the account-payable information obtained.

The present invention (7) provides a concentrated fund-management program for concentrating and managing funds of companies constituting a group in a fund-concentrating account including a single account for each currency unit, the concentrated fund-management program comprising a storing function for storing specifics of a fund balance for each of the companies in the fund-concentrating account; an account-payable-information obtaining function for obtaining account-payable information regarding a price to be paid under a unified settlement condition for payment from a company belonging to the group to another company belonging to the group; and an updating function for updating the stored fund balance based on the account-payable information obtained by the account-payable-information obtaining function.

The present invention (8) provides a computer-readable storage medium storing a concentrated fund-management program for concentrating and managing funds of companies constituting a group in a fund-concentrating account including a single account for each currency unit, the concentrated fund-management program comprising a storing function for storing specifics of a fund balance for each of the companies in the fund-concentrating account; an account-payable-information obtaining function for obtaining account-payable information regarding a price to be paid under a unified settlement condition for payment from a company belonging to the group to another company belonging to the group; and an updating function for updating the stored fund balance based on the account-payable information obtained by the account-payable-information obtaining function.

### BRIEF DESCRIPTION OF THE DRAWINGS

FIG. 1 is a diagram showing the network configuration of a concentrated fund-management system according to an embodiment.

FIG. 2 is a schematic diagram for explaining the concentrated fund-management system.

FIG. 3 is a diagram for explaining a payment on behalf by the concentrated fund-management system for a transaction among group companies.

FIG. 4 is a diagram showing the configuration of a concentrated fund-management apparatus for implementing the concentrated fund-management system.

FIG. 5 is a diagram for explaining the system configuration of the concentrated fund-management system.

FIG. 6 is a diagram for explaining a relationship between usance and a balance sheet.

FIG. 7 is a diagram showing the configuration of a loaning system implemented by a loaning program.

### BEST MODE FOR CARRYING OUT THE INVENTION

In this embodiment, grace period for payment (hereinafter referred to as usance) is unified among group companies constituting a group, so that fund management for the group companies is facilitated and excesses and deficiencies of funds for the group companies, associated with the unification of usance, are absorbed by a loaning function of a concentrated fund-management system. Furthermore, operation of the concentrated fund-management system becomes efficient by the unification of usance.

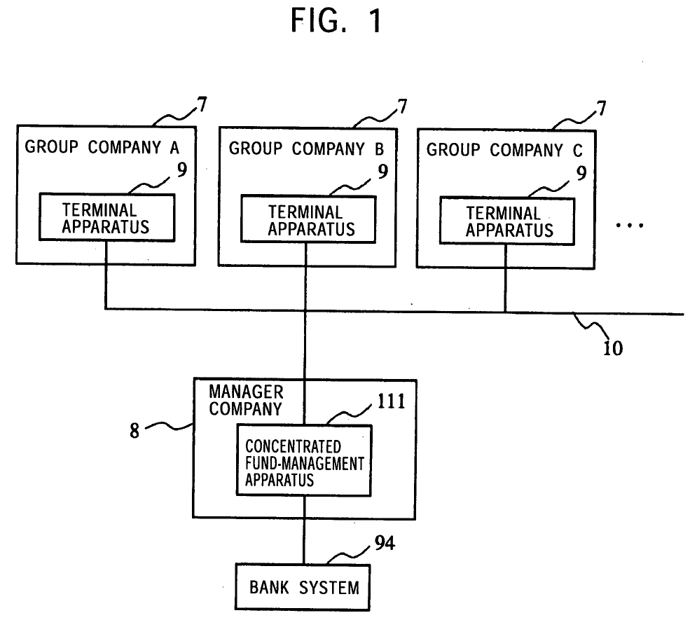

A preferred embodiment of the present invention will now be described in detail with reference to FIGS. 1 to 7.

FIG. 1 is a diagram showing the network configuration of a concentrated fund-management system according to this embodiment.

The concentrated fund-management system includes group companies 7, a manager company 8, and a bank system 94.

Group companies herein generally refer to companies for which some commercial transactions may take place mutually or only from one to another, irrespective of whether mutual capital relationship is present, and are a broader concept than subsidiary companies, affiliate companies, and affiliate corporations. Although only three group companies 7, 7, 7, . . . are shown in FIG. 1, the number of group companies is not limited to three, and participation of more group companies is allowed.

The group companies 7 respectively have terminal apparatuses 9, 9, 9, . . . (hereinafter simply referred to as terminal apparatuses 9 where no distinction is to be made among the terminal apparatuses). The manager company 8 has a concentrated fund-management apparatus 111.

The concentrated fund-management apparatus 111 manages the entire funds of all the group companies 7. The concentrated fund-management apparatus 111 is connected to the bank system 94 via a private line 10. Each of the group companies 7 is allowed to let the concentrated fund-management apparatus 111 to credit or pay on its behalf, to inquire balance, and so forth.

The private line 10 may be replaced by a public circuit, or other types of circuit. In that case, a measure for security is taken, such as encryption of data transmitted.

The manager company 8 is one of the group companies, and is in charge of managing the entire funds of the group companies 7.

The group companies 7, by connecting themselves to the concentrated fund-management apparatus 111, are allowed to receive services provided by the concentrated fund-management system.

Furthermore, although the manager company 8 is in charge of concentrated fund management for the group companies 7 in this embodiment as an example, without limitation thereto, another business entity may be in charge of concentrated fund management; for example, concentrated fund management may be entrusted to a bank.

Now, a scheme of the concentrated fund-management system will be described. According to this embodiment, flow of funds among the group companies 7 becomes efficient by the concentrated fund-management system, and excesses and deficiencies of funds among the group companies 7 are adjusted by the unification of usance.

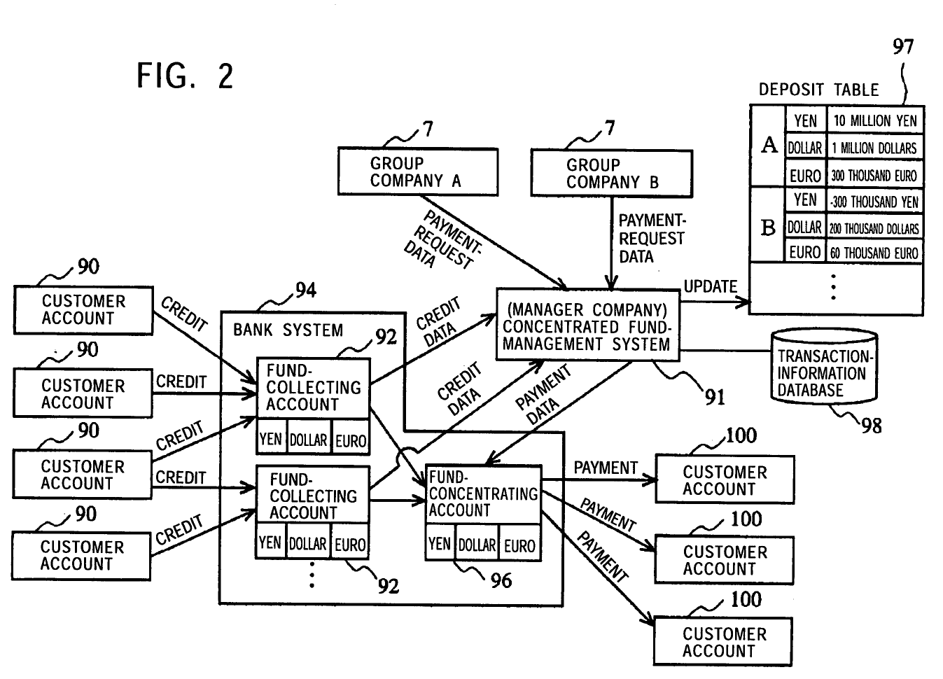

FIG. 2 is a schematic diagram for explaining the concentrated fund-management system.

The concentrated fund-management system concentrates and manages the entire funds of the companies 7, 7, . . . constituting the group in a single account. Although only two group companies 7, 7, . . . are shown in FIG. 2, the number of group companies is not limited to two, and participation of more group companies is allowed.

The concentrated fund-management system includes the bank system 94. The bank system 94 is an electronic system provided in a bank, and is implemented, for example, by a computer such as a server apparatus. The bank system 94 operates according to a predetermined program executed by a CPU (central processing unit) provided in the bank system 94, as will be described below.

The bank system 94 includes fund-collecting accounts 92, 92, . . . (hereinafter referred to as fund-collecting accounts 92), and a fund-concentrating account 96.

The fund-collecting accounts 92 are provided respectively for the group companies 7, and are used when the group companies 7 receive payments from customers outside the group. Each of the group companies 7 arranges an agreement in advance with customers outside the group that payments be transferred to the fund-collecting account 92.

Although the fund-collecting account 92 is shown as a single account in FIG. 2, accounts are provided respectively for currency units, such as an account for yen, an account for dollar, and an account for euro. Companies outside the group transfer payments to accounts in accordance with currency units for crediting.

Alternatively, the arrangement may be such that credits in different currency units are accepted in a single fund-collecting account 92, and classified on the basis of the currency units when transferred to the fund-concentrating account 96.

The fund-concentrating account 96 is an account for unitarily accumulating and managing funds transferred to the fund-collecting accounts 92. Funds transferred to the fund-collecting accounts 92 are transferred to the fund-concentrating account 96 under the date of transfer. The fund-concentrating account 96 is segmented on the basis of currency units, and payments transferred to the fund-collecting accounts 92 are transferred to the corresponding segments of the fund-concentrating account 96 on the basis of the currency units thereof.

In this embodiment, as an example, the fund-concentrating account 96 is segmented into yen, dollar, and euro.

The bank system 94, upon receiving a credit to the fund-collecting accounts 92 from customer accounts 90, 90, . . . of companies outside the group, transmits credit data associated with the credit to the concentrated fund-management system 91. Also, the bank system 94 updates the balance of funds accumulated in the fund-concentrating account 96 for each of the currency units.

The credit data includes, for example, a name of the company that has made the credit, an account number of the fund-collecting account 92, an amount of credit, a currency unit, and information regarding a credit purpose.

The bank system 94 receives payment data from the concentrated fund-management system 91, and remits a sum specified in the payment data to customer accounts 100, 100, . . . of companies outside the group from the funds accumulated in the fund-concentrating account 96.

The payment data includes, for example, a currency unit, an amount of payment, a name of the payee company, a name of a bank and an account number to which the payment is to be made.

As described above, the bank system 94 receives credits for payment from companies outside the group, holds payments received, makes payments to companies outside the group, and so forth.

The concentrated fund-management system 91 allows connecting itself to the bank system 94 and to the terminal apparatuses of the group companies 7 via private lines.

The concentrated fund-management system 91, by using a deposit table 97, manages specifics of funds accumulated in the fund-concentrating account 96 for each of the group companies 7. The deposit table 97 is segmented on the basis of the group companies 7. Each of the segments is further segmented on the basis of currency units of yen, dollar, and euro. Thus, the amount of funds in each of the currency units, owned in the fund-concentrating account 96 by each of the group companies 7, is recorded.

The bank system 94 and the terminal apparatuses of the group companies 7 may be connected via common circuits such as public circuits.

The concentrated fund-management system 91, upon receiving credit data from the bank system 94, adds an amount of credit in a currency unit, included in the credit data, to the balance of a segment of a relevant group company 7, thereby updating the balance.

Furthermore, the concentrated fund-management system 91 receives payment-request data from the group companies 7, and stores the payment-request data in a transaction-information database 98. The payment-request data is created based on an invoice issued from a payee company to a payer company, a bill, etc.

The payment-request data includes a currency unit, an amount of payment, a name of a payee company, payment date information, and usance, and further includes transaction information such as an account number of a customer account 100 of the payee and usance if the payee is a company outside the group. Usance is unified to be 60 days if the payee is a group company 7. Usance herein refers to a grace period for payment. That is, when a company purchases goods or services, payment therefor becomes an account payable and may be delayed for a predetermined period, which is a common practice in commerce.

In this manner, each of the group companies 7 requests the concentrated fund-management system 91 to make payments on its behalf for accounts payable.

Furthermore, settlement date is unified among the group companies. For example, if settlement date is the 15th of each month, commercial transactions made in April among the group companies are all settled on June 15.

Of payment-request data registered in the transaction-information database 98, for payment-request data for which a settlement date as determined by usance has come, a payment transaction is executed by the concentrated fund-management system 91.

If the payee is a group company 7, the balance in the deposit table 97 is simply updated. That is, if a group company A pays 1 million yen to a group company B, 1 million yen is subtracted from the balance of the group company A and 1 million yen is added to the balance of the group company B in the deposit table 97.

Furthermore, for example, in the above example, with regard to sums to be settled on the settlement date of June 15, transactions made in April by all the group companies are summed, and the deposit table 97 is updated using the data.

As described above, updating of the deposit table 97 is facilitated by the unification of usance and settlement date among the group companies.

Furthermore, since settlement date is unified, netting can also be executed effectively, as will be described later.

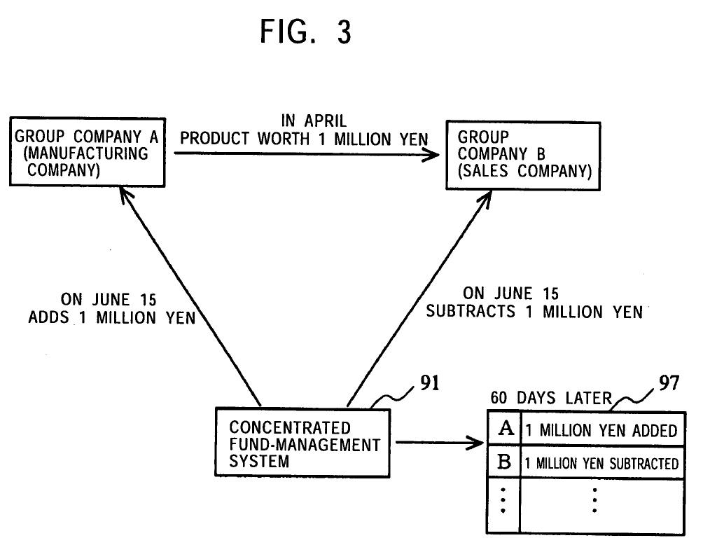

FIG. 3 is a diagram for explaining payment on behalf by the concentrated fund-management system 91 for a transaction among the group companies (for which usance is unified to be 60 days).

Let it be supposed that a group company A sold a product worth 1 million yen to a group company B in April. The account payable of the group company A to the group company B is recorded in the transaction-information database 98 of the concentrated fund-management system 91. On June 15, 1 million yen is added to the balance of the group company A and 1 million yen is subtracted from the balance of the group company B in the deposit table 97.

If the payee is a company outside the group, the concentrated fund-management system 91 creates payment data, and transmits the payment data to the bank system 94. The bank system 94 remits a specified sum from the fund-concentrating account 96 to a specified customer account 100 based on the payment data received.

Furthermore, the concentrated fund-management system 91 has a function for providing loans to the group companies 7. Two methods of loaning are available. In one method, negative balances in the deposit table 97 are allowed, whereby loans are provided to the group companies 7. In another method, desired sums are loaned from funds accumulated in the fund-concentrating account 96 in response to applications from the group companies 7, which will be referred to as inter-company loaning.

In this embodiment, usance of transactions among the group companies 7 is unified to be 60 days. Thus, group companies 7 for which usance is shortened become short of funds while group companies 7 for which usance is extended have excess funds. The excess funds are deposited in the fund-concentrating account 96, and for the deficiencies of funds, loans are provided to the group companies 7 by allowing negative balances or by inter-company loaning. Thus, the excesses and deficiencies of funds, caused by the unification of usance, are adjusted by the loaning function of the concentrated fund-management system 91.

The concentrated fund-management system 91 (FIG. 2) also has a function of exchanging between currency units. This allows the group companies 7 to exchange a balance in the deposit table 97 in one currency unit into another currency unit. Exchange rates are set in the concentrated fund-management system 91.

An exchange is requested by a group company 7 transmitting exchange-request data to the concentrated fund-management system 91. The exchange-request data includes, for example, data including a currency unit before exchange, a currency unit after exchange, an amount of exchange, and a date of exchange.

Based on the exchange-request data received from the group company, the concentrated fund-management system 91 subtracts from the balance of the company in the currency unit before exchange and adds to the balance in the currency unit after exchange in the deposit table 97 on the date of exchange.

Accordingly, for example, a group company A is allowed to exchange a payment received in dollar into yen, and to exchange a balance accumulated in yen into euro for payment to a foreign company.

The manager company has a dedicated dealer. The dealer predicts amounts and periods of exchanges by the group companies 7, and executes dealing by currency hedging, etc. so that the amount of funds in the fund-concentrating account 96 will be exchanged most advantageously.

Thus, the total balance in the fund-concentrating account 96 does not necessarily coincide with the balances in the deposit table 97, and the arrangement is such that if a benefit is yielded by dealing, the benefit is returned to the group companies 7.

Although the manager company 8 is in charge of concentrated fund management in this embodiment, without limitation thereto, for example, a company designated from the group companies 7, a company established by the group companies 7 for the purpose of concentrated fund management, or a third party entrusted for concentrated fund management may be in charge of concentrated fund management, managing records of credits to the group companies 7 and making payments on behalf of the group companies 7.

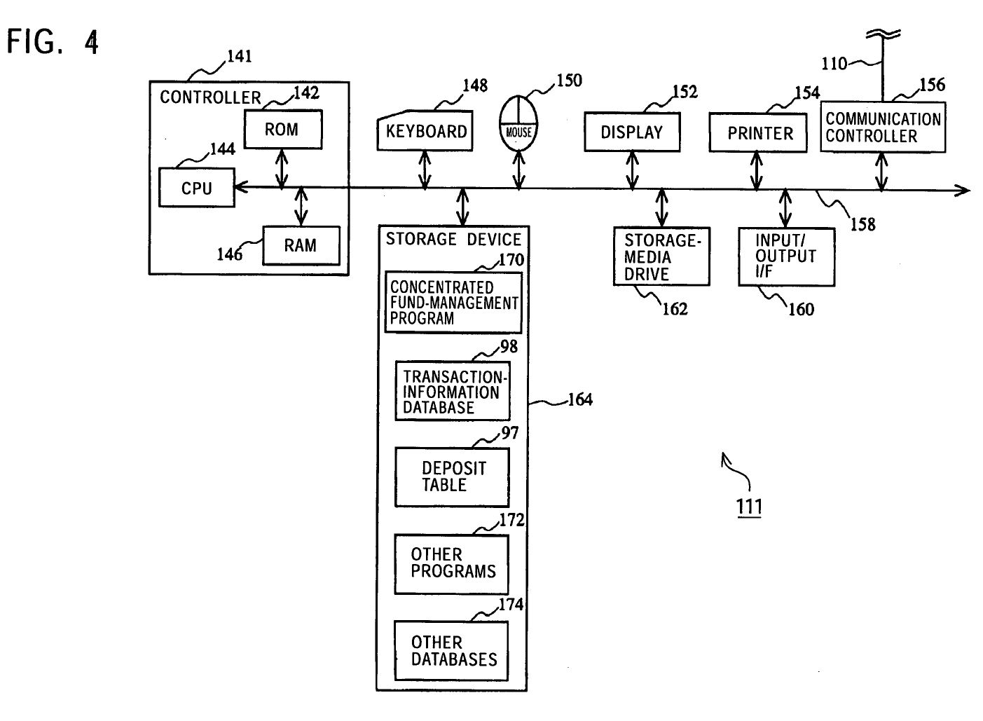

FIG. 4 is a diagram showing the configuration of the concentrated fund-management apparatus 111 that is used to implement the concentrated fund-management system 91.

The concentrated fund-management apparatus 111 includes a keyboard 148, a mouse 150, a display 152, a printer 154, a communication controller 156, a storage device 164, a storage-media drive 162, an input/output interface 160 connected to a controller 141 via a bus line 158.

The controller 141 includes a CPU 144, a ROM (read-only memory) 142, and a RAM (random access memory) 146.

The ROM 142 is a read-only memory storing various programs, data, and parameters for the CPU 144 to execute various operations and controls. The CPU 144 is allowed to read the programs, data, and parameters from the ROM 142, but is not allowed to rewrite or delete these items.

The RAM 146 is a random access memory that is used as a working memory by the CPU 144. The CPU 144 is allowed to write programs, data, etc. to the RAM 146 and to delete these items therefrom. The RAM 146 provides a working area when the CPU 144 updates the deposit table 97, updates the transaction-information database 98, communicates with the terminal apparatuses 9 or the bank system 94, and so forth.

The keyboard 148 is a device for inputting information such as text or numerals to the concentrated fund-management apparatus 111. The keyboard 148 is used when a personnel of the manager company 8 inputs a log-in ID and a password for logging into the concentrated fund-management apparatus 111, or inputs data required in various input fields (e.g., a period to be considered in calculation) on a screen displayed on the display 152 according to a concentrated fund-management program 170.

The keyboard 148 includes keys for inputting Japanese characters, English characters, etc., numeric keys for inputting numerals, various function keys, cursor keys, and other keys.

The mouse 150 is a pointing device. When the concentrated fund-management apparatus 111 is operated using a GUI (graphical user interface) or the like, predetermined information can be input by clicking on a button or icon displayed on the display 152 using the mouse 150.

The keyboard 148 and the mouse 150 described above can be used, for example, when a personnel of the manager company 8 registers a new group company 7, or inputs data needed for maintaining and managing the concentrated fund-management apparatus 111.

The display 152 is an apparatus for presenting information on a screen, and is implemented, for example, by a CRT (cathode ray tube) display, a liquid crystal display, or a plasma display.

The display 152 displays information needed for operating the concentrated fund-management apparatus 111, such as a result of input by the keyboard 148 or the mouse 150, specifics of the deposit table 97, and registered data of the group companies 7.

The printer 154 is used to print data needed for operating the concentrated fund-management apparatus 111, similarly to the display 152, and is implemented by a printer of various types, such as an ink-jet printer, a laser printer, a thermoelectric printer, or a dot printer.

The communication controller 156 is a device for connecting the concentrated fund-management apparatus 111 to the terminal apparatuses 9 or the bank system 94 via private lines 110, and is implemented by a modem, a terminal adapter, or the like.

The communication controller 156 is controlled by the CPU 144 to exchange signals and data with the terminal apparatuses 9 based on a predetermined protocol.

The communication controller 156 is used to receive payment-request data from the terminal apparatuses 9, to receive credit data from the bank system 94, to transmit payment data, and so forth.

The storage device 164 includes a readable and writable storage medium and a drive for reading and writing programs and data from and to the storage medium. The storage medium is typically implemented by a hard disk, but may alternatively be implemented, for example, by a readable and writable storage medium of other types, such as a magneto-optical disk, a magnetic disk, or a semiconductor memory.

The storage device 164 stores the concentrated fund-management program 170, the transaction-information database 98, the deposit table 97, other programs 172, other databases 174, etc.

The concentrated fund-management program 170 allows the concentrated fund-management apparatus 111 to execute a function of concentrated fund management, and it is loaded to and executed by the CPU 144.

The transaction-information database 98 stores payment-request data received by the group companies 7.

The deposit table 97 is a database storing specifics of funds accumulated in the fund-concentrating account 96 for each of the group companies 7.

Other programs 172 include, for example, an OS (operating system) for allowing operation of the concentrated fund-management apparatus 111, and a loaning program for executing loaning (inter-company loaning) to the group companies 7.

Other databases 174 stores a loaning database storing loan balances and loanees, and various registered data of the group companies 7.

The storage-media drive 162 is a drive for driving a removable storage medium to read and write data. The removable storage medium may be, for example, a magneto-optical disk, a magnetic disk, a magnetic tape, a semiconductor memory, a paper tape with data punched thereon, or a CD-ROM. A CD-ROM and a paper tape allow reading only.

The storage-media drive 162 allows backup of data stored in the storage device 164, and also allows a new program to be installed on the concentrated fund-management apparatus 111.

The input/output interface 160 is implemented, for example, by a serial interface or an interface compliant with other standards. The functionality of the concentrated fund-management apparatus 111 can be extended by connecting an external apparatus compatible with the interface to the input/output interface 160. The external apparatus may be, for example, a storage device such as a hard disk, a speaker, or a microphone.

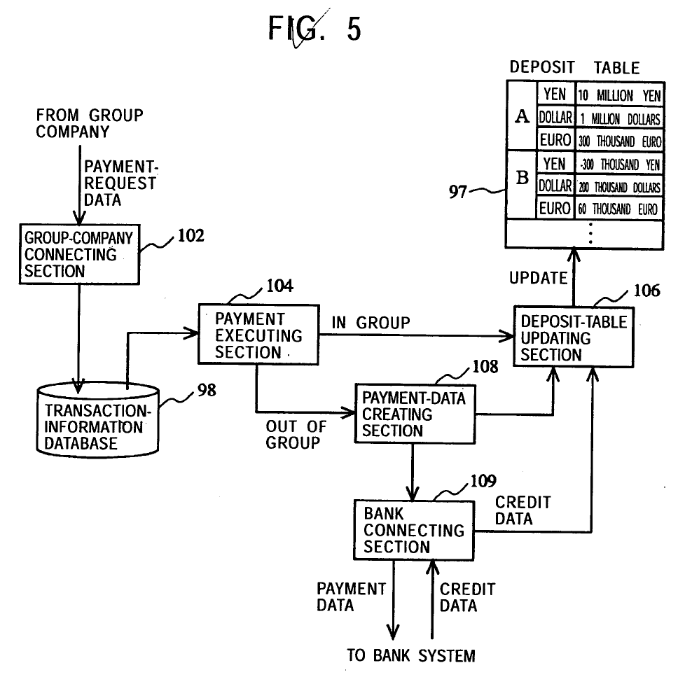

FIG. 5 is a diagram for explaining the system configuration of the concentrated fund-management system 91.

The concentrated fund-management system 91 includes a group-company connecting section 102, a payment executing section 104, a payment-data creating section 108, a deposit-table updating section 106, the transaction-information database 98, and the deposit table 97.

Each of the modules from the group-company connecting section 102 to the deposit-table updating section 106 is implemented in software by the concentrated fund-management program 170 being loaded to the CPU 144. The functions of the sections, described below, are executed by the CPU.

The group-company connecting section 102 receives payment-request data from the terminal apparatuses 9, and stores the payment-request data in the transaction-information database 98.

The payment executing section 104 is activated, for example, once a day, and it searches for all payment-request data for which payment is due on that date. This is because although settlement date is unified to be, for example, 15th of each month among the group companies, settlement date may differ therefrom for transactions between group companies and companies outside the group.

If a payee associated with payment-request data found by the search is a group company 7, the payment-request data is transmitted to the deposit-table updating section 106. Then, the deposit-table updating section 106 subtracts a price to be paid from the balance of the payer company and adds the price to be paid to the balance of the payee company in the deposit table 97 based on the data received from the payment executing section 104. Thus, funds in the fund-concentrating account 96 are not transferred for transactions among the group companies.

If a payee associated with payment-request data found by the search is a company outside the group, the payment executing section 104 transmits the payment-request data to the payment-data creating section 108. Based on the payment-request data, the payment-data creating section 108 creates payment data to be transmitted to the bank system 94, and transmits a name of the payer group company and an amount of payment to the deposit-table updating section 106. The deposit-table updating section 106 obtains the payer group company 7 and the amount of payment from the payment-request data, and subtracts the amount of payment from the balance of the group company 7.

The payment-data creating section 108 transmits the payment data created to the bank system 94 via a bank connecting section 109.

The payment-data creating section 108 creates payment data by aggregating amounts of payment in payment-request data for each of the customer accounts 100, 100, . . . Thus, the payment data represents a total amount of payment for each of the customer accounts 100, 100, . . .

The bank system 94 transfers funds accumulated in the fund-concentrating account 96 to the customer accounts 100, 100, . . . based on the payment data received from the bank connecting section 109.

Furthermore, the bank connecting section 109 has a function of receiving credit data from the bank system 94 and transmitting the credit data to the deposit-table updating section 106. The deposit-table updating section 106 adds a sum credited to the balance of a specified group company 7 based on the credit data received.

Furthermore, data to be transmitted by a group company 7 to the concentrated fund-management system 91 may be classified into a case where a payee for the group company 7 is a group company 7 and a case where the payee is a company outside the group.

In that case, for example, data for requesting payment in a case where a payee is a group company 7 will be referred to as within-group payment-request data, while data for requesting payment in a case where a payee is a company outside the group will be referred to as outside-group payment-request data. The within-group payment-request data is stored in a within-group transaction-information database, while the outside-group payment-request data is stored in an outside-group transaction-information database.

The concentrated fund-management system 91 updates balances in the deposit table 97 using data accumulated in the within-group transaction-information database, thereby settling transactions among the group companies. Furthermore, the concentrated fund-management system 91 creates payment data using data accumulated in the outside-group transaction-information database, and transmits the payment data to the bank system 94. Based on the payment data, the bank system 94 remits specified sums from the fund-concentrating account 96 to the customer accounts 100, 100, 100, . . . .

Next, effect of the unification of usance among the group companies 7 to balance sheets of the group companies 7 and cash flows of the group companies 7 will be described.

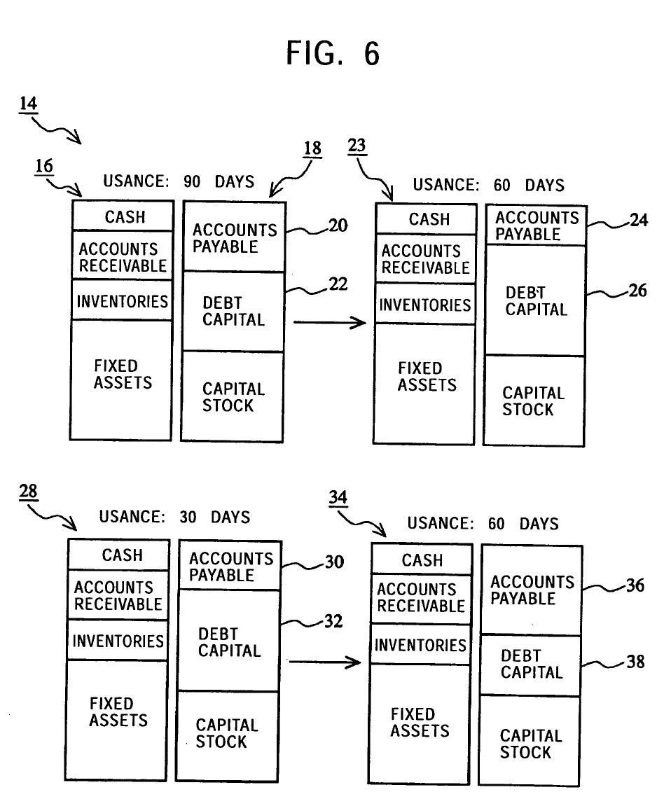

FIG. 6 is a diagram for explaining a relationship between usance and a balance sheet.

A balance sheet is a table showing assets, liabilities, capitals, etc. of a company, and is useful for grasping financial condition of the company. A balance sheet has left and right columns, of which the left column (called the debit side) shows items of assets of the company while the right column (called the credit side) shows items of capitals and liabilities of the company. In other words, the right column indicates how the company has procured funds, while the left column indicates how the company has used the funds procured. The left and right columns are always balanced.

A balance sheet 14 is an example of a balance sheet of a group company A for which usance is set to be 90 days. On the debit side 16 of the balance sheet 14, cash, accounts receivable, inventories, fixed assets, etc. are declared. The cash includes, for example, cash, deposit, etc. The accounts receivable relate to the company A's sales of goods or services on credit for which prices are yet to be collected. The inventories include goods and the like stored in warehouses or the like. The fixed assets include buildings, machineries, and vehicles owned by the group company A.

On the other hand, on the credit side 18, accounts payable 20, debt capitals 22, stockholders' equity, etc. are declared.

The accounts payable 20 are prices yet to be paid of goods and services that the group company A purchased from other companies. The accounts payable are paid to sellers after a predetermined grace period (usance), and they are liabilities without interest.

Debt capitals 22 are debts for loans that the group company A received from banks or other companies, and they are liabilities with interest.

Stockholder's equity is funds that the group company A procured from stockholders through a stock market, etc.

A balance sheet 23 is an example of a balance sheet in a case where usance of the group company A is shortened to 60 days;

The accounts payable 20 decrease in sum to become accounts payable 24. This is because accounts payable is reduced by an amount for 30 days since usance is shortened from 90 days to 60 days.

On the other hand, the debt capitals 22 increase in sum to become debt capitals 26. This is because debt capitals are procured (e.g., funds are loaned from a bank, etc.) so that financing will be in time for a due date of payment in accordance with usance being shortened.

As described above, when usance is shortened, liabilities without interest (accounts payable) decrease and liabilities with interest (debt capitals) increase.

A balance sheet 28 is a balance sheet of a group company B for which usance is set to be 30 days. A balance sheet 34 is a balance sheet of the group company B in a case where usance is extended to 60 days.

Accounts payable 30 increase in sum to become accounts payable 36. This is because accounts payable 30 are increased by an amount for 30 days since usance is extended from 30 days to 60 days.

On the other hand, debt capitals 32 decrease in sum to be come debt capitals 38. This is because financing is facilitated because of usance being extended, and dependency on debt capitals is thus reduced.

As described above, when usance is extended, liabilities without interest (accounts payable) increase while liabilities with interest (debt capitals) decrease.

As described above, since the sum of debt capitals change depending on the length of usance, financing becomes more difficult for group companies 7 for which usance is shortened while financing is facilitated for group companies 7 for which usance is extended.

Accordingly, in this embodiment, in order to aid financing for group companies 7. for which financing becomes more difficult by the unification of usance, two systems are provided, namely, allowance of negative balances, and inter-company loaning.

Furthermore, the unification of usance allows balance sheets of the group companies 7 to be compared more fairly, facilitating comparison of earning capacities of the group companies 7.

Furthermore, negative balances in the deposit table 97 are allowed within maximum sums depending on credit worthinesses of the group companies 7. The maximum sums are recorded in a negative-balance maximum-sum database that is not shown, and the concentrated fund-management system 91 checks so that the balances of the group companies 7 will not exceed the negative-balance maximum sums. If a maximum sum is exceeded, updating of the balance of the relevant group company 7 is stopped, and an alarm is displayed on the display 152 (FIG. 4).

Furthermore, setting of a maximum sum of inter-company loaning for each of the group companies 7 is allowed. Furthermore, the concentrated fund-management system 91 may check so that the amount of negative balance and the amount of inter-company loaning of each of the group companies will not exceed a predetermined maximum sum set for the group company.

As described above, if a balance in the deposit table 97 becomes negative, the negative amount of the balance becomes a loan to the relevant group company 7. In this embodiment, the group company that has received the loan by the above method reimburses the loan with a predetermined interest added. The interest is calculated using, for example, an amount of loaning and a period of loaning as parameters. A section for calculating the interest is implemented by the concentrated fund-management program 170.

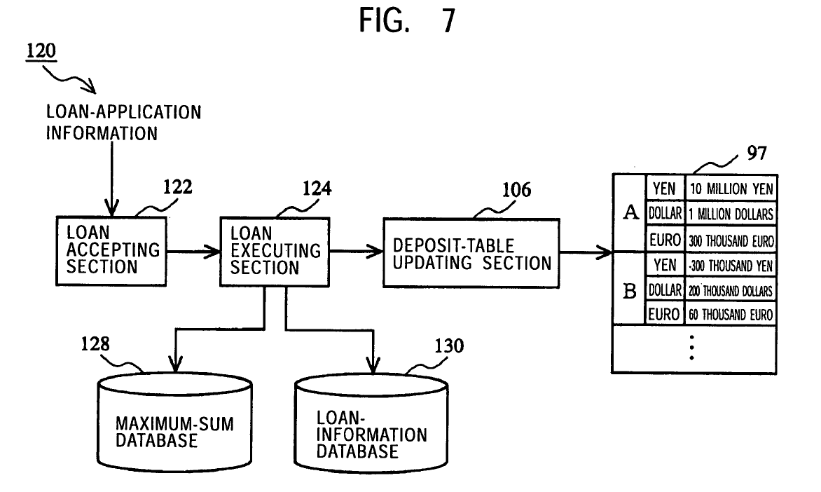

FIG. 7 is a diagram showing the configuration of a loaning system 120, which is implemented by a loaning program included in other programs 172 (FIG. 4) being loaded to the CPU 144.

This system is used to provide inter-company loaning to the group companies 7.

A loan accepting section 122, a loan executing section 124, and the deposit-table updating section 106 are implemented by the loaning program, and the deposit-table updating section 106 and the deposit table 97 are shared with the concentrated fund-management system 91.

The loaning program and the concentrated fund-management program 170 can be executed simultaneously, and the deposit-table updating section 106 can be shared between the programs.

A maximum-sum database 128 and a loan-information database 130 are included in other databases 174 (FIG. 4).

The maximum-sum database 128 stores maximum sums for loaning depending on credit worthinesses of the group companies 7.

The loaning-information database 130 stores current status of loaning to each of the group companies 7, including an amount of loaning and a period of loaning.

The loan accepting section 122 displays a loan accepting screen on a display of a terminal apparatus 9 of a group company 7, and accepts an application for loaning or application for reimbursement from a terminal apparatus 9 and transmits it to the loan executing section 124 via the communication controller 156.

A personnel of the group company 7 inputs predetermined input items on the loan accepting screen displayed on the terminal apparatus 9 to apply for a loan or to reimburse a loan.

The loan accepting section 122 creates loan-application data if information input from the terminal apparatus 9 involves an application for a loan while creating loan-reimbursement data if the information involves reimbursement of a loan, transmitting the data to the loan executing section 124.

The loan-application data includes, for example, information for identifying a group company 7, an amount of loaning, and a period of loaning. The loan-reimbursement data includes an amount of reimbursement, information identifying a particular loan associated with the reimbursement if the group company 7 has received a plurality of loans.

The loan executing section 124 receives loan-application data or loan-reimbursement data from the loan accepting section 122, and executes a transaction for executing loaning or reimbursement of a loan.

In the transaction for executing loaning, whether loaning is acceptable is determined based on loaning conditions (e.g., maximum sum for loaning) of the relevant group company 7, stored in the maximum-sum database 128, and based on current status of loaning to the relevant group company 7, stored in the loaning-information database 130.

If loaning is acceptable, an instruction is issued to the deposit-table updating section 106 so that the amount of loaning will be added to the balance of the relevant group company 7 in the deposit table 97, and the loaning-information database 130 is updated.

If it is determined that loaning is not acceptable, a signal to the effect that loaning is not acceptable is transmitted to the loan accepting section 122, and the loan executing section 124 displays on the terminal apparatus 9 a message to the effect that loaning is not acceptable.

In the transaction for reimbursement of a loan, an instruction is issued to the deposit-table updating section 106 so that the amount of reimbursement will be subtracted from the balance of the relevant group company 7, and the loan-information database 130 is updated.

The maximum-sum database 128 stores loaning conditions such as a maximum sum and a period for loaning for each of the group companies 7, and the loaning conditions are set depending on credit worthinesses, etc. of the group companies 7.

The loan-information database 130 stores current loan information of each of the group companies 7. The loan-information database 130 stores an amount to be reimbursed, a loaning period, an interest, etc. of each loan for each of the group companies 7. Furthermore, an interest calculating section that is not shown is provided, which calculates an interest for each loan stored in the loan-information database 130 and updates the loan-information database 130.

As described above, a method of loaning to the group companies 7 may be a negative balance in the deposit table 97 or inter-company loaning.

Various interest rates for these loaning methods may be set. The interest rate for loaning by a negative balance may be set to be higher or lower than that for loaning by inter-company loaning. The interest rates may be set to be the same.

These loaning conditions are set in accordance with actual businesses of the entire group.

The embodiment described above serves to achieve the following advantages.

Since usance for settlement is unified among the group companies 7, the concentrated fund-management system 91 need not update the deposit table 97 based on usances of the respective group companies 7, so that updating of the deposit table 97 is facilitated.

Furthermore, the unification of usance allows real capabilities of the group companies 7, which have not hitherto been apparent on balance sheets, to be represented on balance sheets. That is, accounts payable (liabilities without interest) that have hitherto been caused due to a long usance become debt capital by shortening the usance. The reverse case also exists. Accordingly, balance sheets of the group companies 7 can be compared on an equal basis.

That is, the unification of usance allows the group companies 7 to be compared more fairly with respect to, for example, a management index calculated based on data on balance sheets.

Deficiencies of funds are caused for group companies 7 for which usance is shortened, and excesses of funds are caused for group companies 7 for which usance is extended; however, deficiencies and excesses of funds are substantially balanced for the group as a whole. Thus, deficiencies and excesses of funds can be absorbed by letting group companies 7 with excess funds credit the excess funds in the fund-concentrating account 96 while providing loans to group companies 7 with deficiencies of funds.

Since a loaning method can be selected from a negative balance in the deposit table 97 and inter-company loaning, a group company 7 is allowed to choose a more advantageous loaning method depending on cases.

Since usance is unified for transactions within a group, payment on behalf by the concentrated fund-management system 91 is simplified.

Furthermore, payments among group companies can be settled only by updating balances in the deposit table 97, so that transfer charges and work of transfer are saved.

Although settlement date is unified among the group companies in the embodiment, without limitation thereto, usance may be unified without unifying settlement date.

The concentrated fund-management program 170, etc. may be stored in, for example, a magneto-optical disk for distribution.

According to the present invention, in cashless settlement in the fund-concentrating account, settlements are executed on the same date among group companies, so that updating of deposit balances is facilitated.

The concentrated fund-management system described above serves to alleviate or prevent occurrence of transfer charges, streamline accounting tasks, utilize funds efficiently, avoid settlement risks (failure of settlement), and so forth.

1. A concentrated fund-management system comprising:
a deposit table for storing specifics of a fund balance for each company in a fund-concentrating account;
account-payable-information obtaining means for obtaining account-payable information regarding a price to be paid under a unified settlement condition for payment from a company belonging to a group to another company belonging to the group; and
updating means for updating a balance in the deposit table based on the account-payable information obtained by the account-payable-information obtaining means.

2. A concentrated fund-management system according to claim 1, wherein a negative balance within a predetermined amount is allowed in the deposit table, and loaning means for loaning a fund to a company belonging to the group in response to a request from the company is further provided.

3. A concentrated fund-management method for a computer comprising a deposit table, account-payable-information obtaining means, and updating means, the computer being used for concentrating and managing funds of companies constituting a group in a fund-concentrating account including a single account for each currency unit, the concentrated fund-management method comprising:
a storing step of storing in the deposit table specifics of a fund balance for each of the companies in the fund-concentrating account;
an account-payable-information obtaining step of obtaining, by the account-payable-information obtaining means, account-payable information regarding a price to be paid under a unified settlement condition for payment from a company belonging to the group to another company belonging to the group; and
a step of updating, by the updating means, a balance in the deposit table based on the account-payable information obtained.

4. A concentrated fund-management program for concentrating and managing funds of companies constituting a group in a fund-concentrating account including a single account for each currency unit, the concentrated fund-management program comprising:
a storing function for storing specifics of a fund balance for each of the companies in the fund-concentrating account;
an account-payable-information obtaining function for obtaining account-payable information regarding a price to be paid under a unified settlement condition for payment from a company belonging to the group to another company belonging to the group; and
an updating function for updating the stored fund balance based on the account-payable information obtained by the account-payable-information obtaining function.

5. A computer-readable storage medium storing a concentrated fund-management program for concentrating and managing funds of companies constituting a group in a fund-concentrating account including a single account for each currency unit, the concentrated fund-management program comprising:
a storing function for storing specifics of a fund balance for each of the companies in the fund-concentrating account;
an account-payable-information obtaining function for obtaining account-payable information regarding a price to be paid under a unified settlement condition for payment from a company belonging to the group to another company belonging to the group; and
an updating function for updating the stored fund balance based on the account-payable information obtained by the account-payable-information obtaining function.
